(19) United States
(12) Patent Application Publication
(10) Pub. No.: US 2018/0004102 A1
(43) Pub. Date: Jan. 4, 2018

(54) METHOD FOR MANUFACTURING FLUORINATED STRUCUTURED ORGANIC PHOTORECEPTOR LAYERS

(71) Applicant: Xerox Corporation, Norwalk, CT (US)

(72) Inventors: Gregory M. McGuire, Oakville (CA); Suxia Yang, Mississauga (CA); Kimberly D. Nosella, Mississauga (CA); Nan-Xing Hu, Oakville (CA); Edward C. Savage, Webster, NY (US); Robert W. Hedrick, Spencerport, NY (US)

(21) Appl. No.: 15/198,665

(22) Filed: Jun. 30, 2016

(51) Int. Cl. G03G 5/147; C23C 2/26

(52) U.S. Cl. CPC G03G 5/14708; C23C 2/26

(57) ABSTRACT

Disclosed herein is a method for manufacturing a fluorinated structured organic film (FSOF) composition for a photoreceptor. The method includes combining a fluorinated diol, an electroactive segment and a solvent in a round bottom reactor. The reacted is heated, without mixing dissolve the fluorinated diol composition. The dissolved fluorinated diol composition is mixed to dissolve the electroactive segment while maintaining the reactor at a temperature of between 80 and 85° C. A catalyst and a leveling agent are added to the solution to initiate a pre-cure reaction. The pre-cure reaction proceeds for at least 2 hours at a temperature of between 80 and 85° C. The solution is cooled to room temperature and filtered.

### BACKGROUND

### Field of Use

The present disclosure relates to a method for manufacturing protective overcoats for imaging members. More particularly, there is provided a method for providing a structured organic film used an overcoat for a photoreceptor.

### Background

In electrophotography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is exposed to a pattern of activating electromagnetic radiation, such as light. The radiation selectively dissipates the charge on the illuminated areas of the photoconductive insulating layer while leaving behind an electrostatic latent image on the non-illuminated areas. This electrostatic latent image may then be developed to form a visible image by depositing finely divided electroscopic marking particles on the surface of the photoconductive insulating layer. The resulting visible image is transferred from the imaging member directly or indirectly (such as by a transfer or other member) to a print substrate, such as transparency or paper. The imaging process may be repeated many times with reusable imaging members.

Although excellent toner images may be obtained with multilayered belt or drum photoreceptors, it has been found that as more advanced, higher speed electrophotographic copiers, duplicators, and printers are developed, there is a greater demand on print quality. The delicate balance in charging image and bias potentials, and characteristics of the toner and/or developer, must be maintained. This places additional constraints on the quality of photoreceptor manufacturing, and thus on the manufacturing yield.

Imaging members are generally exposed to repetitive electrophotographic cycling, which subjects the exposed charged transport layer or alternative top layer thereof to mechanical abrasion, chemical attack and heat. This repetitive cycling leads to gradual deterioration in the mechanical and electrical characteristics of the exposed charge transport layer. Physical and mechanical damage during prolonged use, especially the formation of surface scratch defects, is among the chief reasons for the failure of belt photoreceptors. Therefore, it is desirable to improve the mechanical robustness of photoreceptors, and particularly, to increase their scratch resistance, thereby prolonging their service life. Additionally, it is desirable to increase resistance to light shock so that image ghosting, background shading, and the like is minimized in prints.

Providing a protective overcoat layer is a conventional means of extending the useful life of photoreceptors. For example, a polymeric anti-scratch and crack overcoat layers have been utilized as a robust overcoat design for extending the lifespan of photoreceptors.

U.S. Pat. No. 8,237,566 discloses a method of manufacturing a fluorinated structured organic film. However, the process described is not as robust or scalable as required for commercial manufacturing. It would be desirable to provide a more robust and scalable process for manufacturing protective overcoats for a photoreceptor.

### SUMMARY

According to an embodiment, there is provided a method for manufacturing a fluorinated structured organic film (FSOF) composition for a photoreceptor. The method includes combining a fluorinated diol, an electroactive segment and a solvent to form a composition. The composition is added to a round bottom glass reactor and heated to a temperature of between 80 and 85° C. for a period of time to dissolve the fluorinated diol composition. The heating is done without mixing. The dissolved fluorinated diol composition is mixed for period of time sufficient to dissolve the electroactive segment while maintaining the reactor at a temperature of between 80 and 85° C. and form a solution. A catalyst and leveling agent are added to the solution to initiate a pre-cure reaction. The pre-cure reaction is conducted for at least 2 hours at a temperature of between 80 and 85° C. The solution is cooled to room temperature and filtered.

According to another embodiment there is provided a method of manufacturing a fluorinated structured organic film (FSOF) composition. The method includes combining a fluorinated molecular building block, a hole transport building block and a solvent in a round bottom reactor. The method includes heating, without mixing, the round bottom reactor to a temperature of between 72° C. and 85° C. for a period of time to dissolve the fluorinated molecular building block. The method includes mixing the heated mixture at a first speed and then increasing the mixing to a second speed for the period of time sufficient to dissolve the hole transport building block at a temperature of between 72° C. and 85° C. The method includes adding a catalyst and a leveling agent to the mixed heated mixture to initiate a pre-cure reaction and allowing the pre-cure reaction to proceed for at least 2 hours at a temperature of between 72° C. and 85° C. to form a pre-cure composition. The pre-cure composition is cooled to room temperature and filtered.

According to another embodiment, there is provided a method for manufacturing a fluorinated structured organic film (FSOF) composition. The method combining 1,1,8,8-dodecafluoro-1,8-octanediol, N4,N4,N4′,N4′-tetrakis(4-(methoxymethyl)phenyl)biphenyl-4,4′-diamine and dipropylene glycol methyl ether to form a composition and adding the composition to a round bottom non-reactive reactor. The method includes heating, without mixing, the round bottom non-reactive reactor to a temperature of between 80 and 85° C. for a period of time sufficient to dissolve the 1,1,8,8-dodecafluoro-1,8-octanediol in the dipropylene glycol methyl ether. The method includes mixing the heated mixture for the period of time sufficient to dissolve the N4,N4,N4′,N4′-tetrakis(4-(methoxymethyl)phenyl)biphenyl-4,4′-diamine in the dipropylene glycol methyl ether at a temperature of between 80 and 85° C. The method includes adding an acid catalyst and leveling agent to the mixed heated mixture to initiate a pre-cure reaction and allowing the pre-cure reaction to proceed for at least 2 hours at a temperature of between 80 and 85° C. to form a pre-cure composition. The pre-cure composition is cooled to room temperature and filtered.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic of the chemical reaction that forms a fluorinated structured organic film.

FIG. 2 shows aging results for stored FSOF compositions after 1 month at ambient and frozen temperatures.

FIG. 3 shows wear rate results for stored and coated FSOF compositions after 1 month at ambient and frozen temperatures.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

The term fluorinated structured organic film “FSOF” refers, for example, to a structured organic film that contains fluorine atoms covalently bonded to one or more segment types or linker types of the SOF. The fluorinated SOFs of the present disclosure may further include fluorinated molecules that are not covalently bound to the framework of the SOF, but are randomly distributed in the fluorinated SOF composition (i.e., a composite fluorinated SOF). However, an SOF, which does not contain fluorine atoms covalently bonded to one or more segment types or linker types of the SOF, that merely includes fluorinated molecules that are not covalently bonded to one or more segments or linkers of the SOF is a composite SOF, not a fluorinated SOF.

U.S. Pat. No. 8,372,566, incorporated herein by reference, discloses FSOF films containing fluorinated segments and electroactive segments. It has been found that various problems occur in the dissolution of the ingredients which causes a sticky paste to adhere to the side of the reaction vessel. In addition the method discloses in U.S. Pat. No. 8,372,566 leads to poor solution stability and unpredictable pot life.

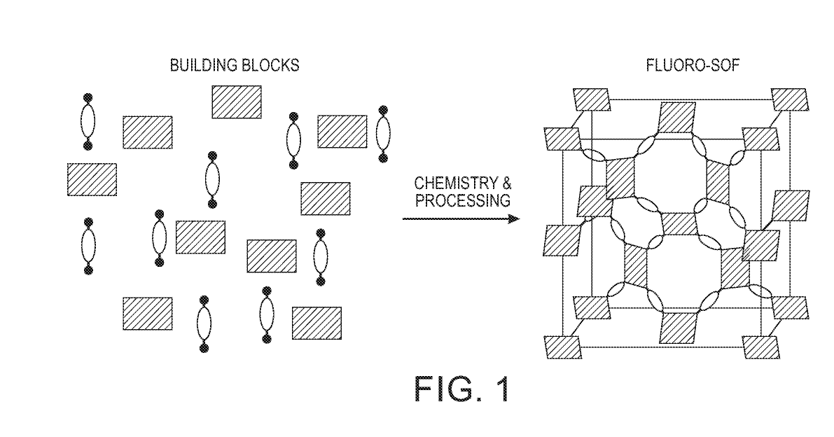

The method disclosed herein involves reacting molecular building blocks together to form a robust network structure that provides scratch resistance, low wear, and unlike other cross-linked designs, no significant impact on charge mobility. Shown in FIG. 1 is a schematic of the Fluorinated Structured Organic Film (FSOF) design. The hole transport building blocks or electroactive segments are represented by the rectangles. The fluorinated building blocks or fluorinated diols are represented by the elliptical segments having a functional group at each end. By reacting the two types of molecular building blocks a film is formed.

The FSOFs of the present disclosure comprise molecular building blocks having a segment (S) and functional groups (Fg). Molecular building blocks require at least two functional groups (x≧2) and may comprise a single type or two or more types of functional groups. Functional groups are the reactive chemical moieties of molecular building blocks that participate in a chemical reaction to link together segments during the FSOF forming process. A segment is the portion of the molecular building block that supports functional groups and comprises all atoms that are not associated with functional groups. Further, the composition of a molecular building block segment remains unchanged after SOF formation.

Molecular building block symmetry relates to the positioning of functional groups (Fgs) around the periphery of the molecular building block segments. Without being bound by chemical or mathematical theory, a symmetric molecular building block is one where positioning of Fgs may be associated with the ends of a rod, vertexes of a regular geometric shape, or the vertexes of a distorted rod or distorted geometric shape. For example, the most symmetric option for molecular building blocks containing four Fgs are those whose Fgs overlay with the corners of a square or the apexes of a tetrahedron.

Use of symmetrical building blocks is practiced in embodiments of the present disclosure for two reasons: (1) the patterning of molecular building blocks is better anticipated because the linking of regular shapes is a better understood process in reticular chemistry, and (2) the complete reaction between molecular building blocks is facilitated because for less symmetric building blocks errant conformations/orientations may be adopted which can possibly initiate numerous linking defects within FSOFs.

In embodiments, the outermost layer of the imaging members and/or photoreceptors comprises patterned FSOFs having different degrees of patterning. For example, the patterned FSOF may exhibit full patterning, which may be detected by the complete absence of spectroscopic signals from building block functional groups. In other embodiments, the patterned FSOFs having lowered degrees of patterning wherein domains of patterning exist within the FSOF.

The fluorinated building blocks may include, for example, α, ω-fluoroalkyldiols of the general structure:

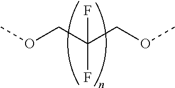

where n is an integer having a value of 1 or more, such as from 1 to about 100, or 1 to about 60, or about 2 to about 30, or about 4 to about 10; or fluorinated alcohols of the general structure HOCH₂(CF₂).CH₂OH and their corresponding dicarboxylic acids and aldehydes, where n is an integer having a value of 1 or more, such as from 1 to about 100, or 1 to about 60, or about 2 to about 30, or about 4 to about 10; tetrafluorohydroquinone; perfluoroadipic acid hydrate, 4,4′-(hexafluoroisopropylidene)diphthalic anhydride; 4,4′-(hexafluoroisopropylidene)diphenol, and the like.

Examples of the fluorinated building blocks include fluorinated diols selected from the group consisting of: 1,1,8,8-dodecafluoro-1,8-octanediol, 2,2,3,3,4,4,5,5-octafluoro-1,6-hexanediol, 2,2,3,3,4,4,5,5,6,6,7,7-dodecanfluoro-1,8-octanediol, 2,2,3,3,4,4,5,5,6,6,7,7,8,8,9,9-perfluorodecane-1,10-diol, (2,3,5,6-tetrafluoro-4-hydroxymethyl-phenyl)-methanol, 2,2,3,3-tetrafluoro-1,4-butanediol, 2,2,3,3,4,4-hexafluoro-1,5-pentanedial, and 2,2,3,3,4,4,5,5,6,6,7,7,8,8-tetradecafluoro-1,9-nonanediol.

The term electroactive refers, for example, to the property to transport electrical charge (electrons and/or holes). Examples of hole transport building blocks having electroactive properties, include N,N,N′,N′-tetrakis-[(4-hydroxymethyl)phenyl]-biphenyl-4,4′-diamin-e, having a hydroxyl functional group (—OH) and upon reaction results in a segment of N,N,N′,N′-tetra-(p-tolyl)biphenyl-4,4′-diamine; and/or N,N′-diphenyl-N,N′-bis-(3-hydroxyphenyl)-biphenyl-4,4′-diamine, having a hydroxyl functional group (—OH) and upon reaction results in a segment of N,N,N′,N′-tetraphenyl-biphenyl-4,4′-diamine.

Hole transport building blocks having added functionality may be obtained by selecting segment cores such as, for example, triarylamines, hydrazones (U.S. Pat. No. 7,202,002 B2 to Tokarski et al.), and enamines (U.S. Pat. No. 7,416,824 B2 to Kondoh et al.) with the following general structures:

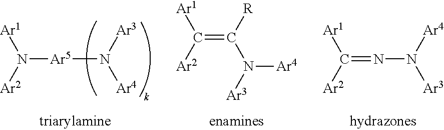

The segment core comprising a triarylamine being represented by the following general formula:

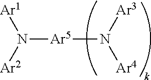

wherein Ar¹, Ar², Ar³, Ar⁴ and Ar⁵ each independently represents a substituted or unsubstituted aryl group, or Ar⁵ independently represents a substituted or unsubstituted arylene group, and k represents 0 or 1. Ar⁵ may be further defined as, for example, a substituted phenyl ring, substituted/unsubstituted phenylene, substituted/unsubstituted monovalently linked aromatic rings such as biphenyl, terphenyl, and the like, or substituted/unsubstituted fused aromatic rings such as naphthyl, anthranyl, phenanthryl, and the like.

Segment cores comprising arylamines with hole transport added functionality include, for example, aryl amines such as triphenylamine, N,N,N′,N′-tetraphenyl-(1,1′-biphenyl)-4,4′-diamine, N,N-diphenyl-N,N′-bis(3-methylphenyl)-(1,1′-biphenyl)-4,4′-diamine, N,N′-bis(4-butylphenyl)-N,N′-diphenyl-[p-terphenyl]-4,4″-diamine; hydrazones such as N-phenyl-N-methyl-3-(9-ethyl)carbazyl hydrazone and 4-diethyl amino benzaldehyde-1,2-diphenyl hydrazone; and oxadiazoles such as 2,5-bis(4-N,N′-diethylaminophenyl)-1,2,4-oxadiazole, stilbenes, and the like.

The segment core comprising a hydrazone being represented by the following general formula:

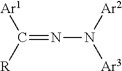

wherein Ar¹, Ar², and Ar³ each independently represents an aryl group optionally containing one or more substituents, and R represents a hydrogen atom, an aryl group, or an alkyl group optionally containing a substituent; wherein at least two of Ar¹, Ar², and Ar³ comprises a Fg (previously defined); and a related oxadiazole being represented by the following general formula:

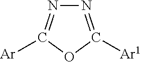

wherein Ar and Ar¹ each independently represent an aryl group that comprises a Fg (previously defined).

The segment core comprising an enamine being represented by the following general formula:

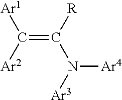

wherein Ar¹, A², A³, and Ar⁴ each independently represents an aryl group that optionally contains one or more substituents or a heterocyclic group that optionally contains one or more substituents, and R represents a hydrogen atom, an aryl group, or an alkyl group optionally containing a substituent; wherein at least two of A¹, A², A³, and Ar⁴ comprises a Fg (previously defined).

Examples of the hole molecular building block include N4,N4,N4′,N4′-tetrakis(4-(methoxymethyl)phenyl)biphenyl-4,4′-diamine N,N,N′,N′-tetra-(p-tolyl)biphenyl-4,4′-diamine: and N4,N4′-bis(3,4-dimethylphenyl)-N4,N4′-di-p-tolyl-[1,1′-biphenyl]-4,4′-diamine.

FSOFs having a rough, textured, or porous surface on the sub-micron to micron scale may also be hydrophobic. The rough, textured, or porous FSOF surface can result from dangling functional groups present on the film surface or from the structure of the FSOF. The type of pattern and degree of patterning depends on the geometry of the molecular building blocks and the linking chemistry efficiency. The feature size that leads to surface roughness or texture is from about 100 nm to about 10 μm, such as from about 500 nm to about 5 μm.

The process described herein utilizes solvents, and/or solvent mixtures. Solvents are used to dissolve or suspend the molecular building blocks and catalyst/modifiers in the reaction mixture. Solvent selection is generally based on balancing the solubility/dispersion of the molecular building blocks and a particular building block loading, the viscosity of the reaction mixture, and the boiling point of the liquid, which impacts the promotion of the wet layer to the dry SOF.

Solvents can include molecule classes such as alkanes (hexane, heptane, octane, nonane, decane, cyclohexane, cycloheptane, cyclooctane, decalin); mixed alkanes (hexanes, heptanes); branched alkanes (isooctane); aromatic compounds (toluene, o-, m-, p-xylene, mesitylene, nitrobenzene, benzonitrile, butylbenzene, aniline); ethers (benzyl ethyl ether, butyl ether, isoamyl ether, propyl ether); cyclic ethers (tetrahydrofuran, dioxane), esters (ethyl acetate, butyl acetate, butyl butyrate, ethoxyethyl acetate, ethyl propionate, phenyl acetate, methyl benzoate); ketones (acetone, methyl ethyl ketone, methyl isobutylketone, diethyl ketone, chloroacetone, 2-heptanone), cyclic ketones (cyclopentanone, cyclohexanone), amines (1°, 2°, or 3° amines such as butylamine, diisopropylamine, triethylamine, diisoproylethylamine; pyridine); amides (dimethylformamide, N-methylpyrrolidinone, N,N-dimethylformamide); alcohols (methanol, ethanol, n-, i-propanol, n-, t-butanol, 1-methoxy-2-propanol, hexanol, cyclohexanol, 3-pentanol, benzyl alcohol); nitriles (acetonitrile, benzonitrile, butyronitrile), halogenated aromatics (chlorobenzene, dichlorobenzene, hexafluorobenzene), halogenated alkanes (dichloromethane, chloroform, dichloroethylene, tetrachloroethane); and water.

Catalyst are utilized in the reaction mixture to assist the promotion of the wet layer to the dry FSOF. Selection and use of the optional catalyst depends on the functional groups on the molecular building blocks. Catalysts may be homogeneous (dissolved) or heterogeneous (undissolved or partially dissolved) and include Bronsted acids (HCl (aq), acetic acid, p-toluenesulfonic acid, amine-protected p-toluenesulfonic acid such as pyrridium p-toluenesulfonate, trifluoroacetic acid); Lewis acids (boron trifluoroetherate, aluminum trichloride); Bronsted bases (metal hydroxides such as sodium hydroxide, lithium hydroxide, potassium hydroxide; 1°, 2°, or 3° amines such as butylamine, diisopropylamine, triethylamine, diisoproylethylamine); Lewis bases (N,N-dimethyl-4-aminopyridine); metals (Cu bronze); metal salts (FeCl₃, AuCl₃); and metal complexes (ligated palladium complexes, ligated ruthenium catalysts). Typical catalyst loading ranges from about 0.01% to about 25%, such as from about 0.1% to about 5% of the molecular building block loading in the reaction mixture. The catalyst may or may not be present in the final SOF composition.

Optionally additives or secondary components, such as dopants, antioxidants and leveling agents may be present in the reaction mixture and wet layer. Such additives or secondary components may also be integrated into a dry SOF. Additives or secondary components can be homogeneous or heterogeneous in the reaction mixture and wet layer or in a dry SOF. The surfactants include hydroxyl-functionalized silicone modified polyacrylates such as SILCLEAN® 3700.

Process for Preparing a Fluorinated Structured Organic Film (FSOF)

The process for making FSOFs of the present disclosure is described below. The process is scalable and provides long shelf life for the FSOF composition.

The process described herein requires all at once addition of molecular building block components and solvent prior to any mixing. The process includes timed addition of catalyst after dissolution of the molecular building blocks in the solvent. The reactor used in the process requires a round bottom, and the reactor is formed from a non-reactive material such as glass. The reactor is sealed to prevent moisture from entering. The reactor walls can be washed with a deferred solvent portion.

Having a reactor with a round bottom prevents dead zones for paste (undissolved solids in the solvent) to accumulate. The reactor is sealed and can be purged with nitrogen to prevent water contamination. The heating system is a temperature controlled water circulating jacket although other heating methods are available. An impeller system with speed control is used for mixing. The solvent is weighed into the reaction vessel with small amounts held back or deferred for Step 2 to rinse the walls of any paste or agglomerates.

In Step 1, the reactant ingredients are added to the vessel. This includes the hole molecular building block, the fluorinated molecular building block and the solvent. The impeller is left off. The composition is heated to between 72° C. and 85° C. for a time sufficient to dissolve the fluorinated molecular building block. The time can be from 1 hour to 4 hours. In embodiments the temperature is between 80° C. and 85° C., or between 82° C. and 85° C. The hole molecular building block powder remains in the solvent forming a slurry in the reactor. This step is done without any mixing to prevent any paste from sticking to the walls.

In Step 2, the portion of solvent that is deferred from the initial addition is injected through the reactor neck in order to wash any solid particulate from the vessel walls into the slurry. This is an optional step, but provides improved robustness in the manufacture of the FSOF composition.

In Step 3, the slurry, having the dissolved fluorinated molecular building block, is mixed slowly by engaging the impeller until the hole molecular building block fully dissolves into the solvent. This is indicated by the solution taking on a dark brown color. At this time the impeller speed in increased and the vessel is completely free of undissolved paste. The solution is mixed to completely dissolve the hole molecular building block while temperature of the reactor is maintained at 72° C. and 85° C., or between 80° C. and 85° C., or between 82° C. and 85° C.

In Step 4, the catalyst and leveling agent are added to the solution. The pre-cure reaction begins. The reaction is allowed to proceed for 3 hours at the temperature in Step 3.

In Step 5, the solution is cooled, discharged, and filtered through a 0.45 micron PTFE filter and is now ready for coating or storage.

While embodiments have been illustrated with respect to one or more implementations, alterations and/or modifications can be made to the illustrated examples without departing from the spirit and scope of the appended claims. In addition, while a particular feature herein may have been disclosed with respect to only one of several implementations, such feature may be combined with one or more other features of the other implementations as may be desired and advantageous for any given or particular function.

### EXAMPLES

A series of FSOF compositions were prepared stored and coated. The FSOF compositions were produced as follows. A solvent, dipropylene glycol methyl ether (Dowanol®), a fluorinated diol (1,1,8,8-dodecafluoro-1,8-octanediol) and a hole transport molecule, N4,N4,N4′,N4′-tetrakis(4-(methoxymethyl)phenyl)biphenyl-4,4′-diamine were weighed and added to a glass lined round bottom reactor having an impeller. The impeller was left off and the reactor was heated to a temperature of from about 80° C. and 85° C. for about 1 hour. This was sufficient to allow the fluorinated diol to dissolve in the solvent. A small portion of the solvent that was deferred was used to wash the walls of the reactor to remove any particulate matter from the walls. The impeller was turned on at a slow speed to prevent splashing. The slurry eventually turned a dark brown color. The impeller speed was increased and the solution was mixed for about one hour dissolving the hole molecular building block. The reactor was maintained at a temperature of from about 80° C. and 85° C. during the mixing. An amine neutralized p-TSA catalyst (Nacure XP-357®) and leveling agent (Silclean 3700) were added to the solution. This initiated the pre-cure reaction. The reactor was held at 80° C. and 85° C. for three hours. The solution was then cooled and filtered through a 0.45 micron PTFE filter and stored.

Solution stability was evaluated over multiple separate batches and showed no propensity for crashing out when cooled or shaken and remained in solution when draw coated or extruded.

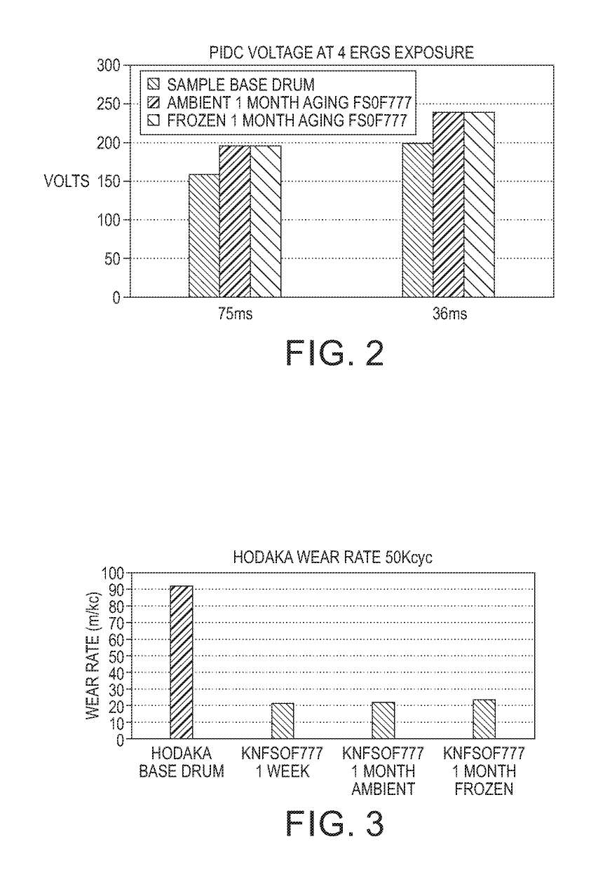

Pot life was evaluated by separating several batches into smaller vessels that were then placed in either ambient conditions on the bench or into a freezer at −20° C. The batches were then coated and cued on a drum. The PIDC voltage was measured for the various batches. This is shown in FIG.2. FIG. 3 shows the wear rate of various drums. Both the ambient and frozen samples were evaluated again for stability, coating quality, and performance at 1 week, 1 month, 3 months, and 6 months. All samples show no change in behavior.

A bulk solution of 2 liters prepared using the disclosed process was used in a dip coating trial (see Table 1 below). The solution was repeatedly charged and discharged into a dip coating tank and used to coat hundreds of drums over the span of 6 months. No issues with stability, coating quality, or performance was observed. No issues with surface morphology, dewetting, streaking, or clarity observed over entire pot-life. FSOF performance was predictable and repeatable over entire pot-life.

TABLE 1
FSOF solution scale up for large dip coating trial

| | Date | | | | | |
|---|---|---|---|---|---|---|
| | 21 Jan. 2015 | 9 Feb. 2015 | 24 Feb. 2015 | 25 Feb. 2015 | 26 Feb. 2015 | 27 Feb. 2015 |
| | Experiment ID | | | | | |
| | KNfSOF777 | KNfSOF785 | KNfSOF794 | KNfSOF795 | KNfSOF796 | KNfSOF797 |
| | Scale | | | | | |
| | 1 L Kettle | 1 L Kettle | 1 L Kettle | 1 L Kettle | 1 L Kettle | 1 L Kettle |
| | Purpose | | | | | |
| | | | Supply for | Supply for | Supply for | Supply for |
| | First Attempt | Sampling | Webster | Webster | Webster | Webster |
| | at scale up | for QC | coating | coating | coating | coating |
| FORMULATION | | | | | | |
| 12 FOD [g] | 107.4 | 107.4 | 107.4 | 107.4 | 107.4 | 107.4 |
| TME-Ab118 [g] | 102.7 | 102.7 | 102.7 | 102.7 | 102.7 | 102.7 |
| Dowanol [g] | 286.3 | 286.3 | 286.3 | 286.3 | 286.3 | 286.3 |
| Silclean 3700 [g] | 8.74 | 8.74 | 8.74 | 8.74 | 8.74 | 8.74 |
| Catalyst (Nacure XP-357) [g] | 10.9 | 10.9 | 10.9 | 10.9 | 10.9 | 10.9 |
| TRIS-TPM [g] | 3.93 | 3.79 | 3.93 | 3.93 | 3.93 | 3.93 |
| Theoretical % solids | 42.0% | 42.0% | 42.0% | 42.0% | 42.0% | 42.0% |
| Theoretical Total Solution [g] | 520.0 | 519.8 | 520.0 | 520.0 | 520.0 | 520.0 |
| Yield [g] | — | — | 487.5 | 502.4 | 498.9 | 501.3 |
| % Yield | — | — | 93.8% | 96.6% | 95.9% | 96.4% |
| REACTOR | | | | | | |
| Impeller set-up | 1 P4 7.5 × 2 cm | 1 P4 7.5 × 2 cm | 1 P4 7.5 × 2 cm | 1 P4 7.5 × 2 cm | 1 P4 7.5 × 2 cm | 1 P4 7.5 × 2 cm |
| PROCESS | | | | | | |
| Temperature [C.] | 81.3 | 81.5 | 81.5 | 81.6 | 81.9 | 81.3 |
| Max Temp during rxn [C.] | 82.2 | 81.7 | 82.6 | 83.3 | 83 | 82.8 |
| Time to dissolve [min] | 64 | 60 | 67 | 65 | 69 | 69 |
| Dissolved to add Catalyst [min] | 16 | 20 | 14 | 9 | 10 | 17 |
| Reaction Run time [min] | 180 | 180 | 180 | 180 | 180 | 180 |
| RPM | 100 | 100 | 100 | 100 | 100 | 100 |
| Nitrogen [SCFH] | on | on | 0.4 | 0.2 | 0.2 | 0.2 |
| Cooling rate [C/min] | 0.5 | 0.4 | 0.54 | 0.39 | 0.43 | 0.52 |
| Glass pipette check | no white | no white | no white | | | |
| | residuals | residuals | residuals | | | |
| Notes: | | | black specks in | black specks in | black specks in | black specks in |
| | | | reactor from | reactor from | reactor from | reactor from |
| | | | TME-AB118 | TME-AB118 | TME-AB118 | TME-AB118 |

The process described herein provides reproducible results for prepared a FSOF composition.

When compared with other methods for producing a FSOF composition, it was found that a round bottom flask is required in the present disclosure. If a round bottomed flask or reactor is not used the components do not dissolve completely and accumulate in the bottom edges of the vessel. Further, if the components are added with mixing then there will be a buildup of undissolved material on the vessel walls. Finally, if the temperature and times are not followed precisely the final product will have an extremely short pot life (if the reaction temperature is too low) or be full of solid reaction product (if the reaction temperature is too high).

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A method of manufacturing a fluorinated structured organic film (FSOF) composition comprising:
combining a fluorinated diol, an electroactive segment and a solvent to form a composition;
adding the composition to a round bottom non-reactive reactor;
heating, without mixing, the round bottom non-reactive reactor to a temperature of between 80 and 85° C. for a period of time to dissolve the fluorinated diol in the solvent;
mixing the heated mixture for the period of time sufficient to dissolve the electroactive segment at a temperature of between 80 and 85° C.;
adding a catalyst and leveling agent to the mixed heated mixture to initiate a pre-cure reaction and allowing the pre-cure reaction to proceed for at least 2 hours at a temperature of between 80 and 85° C. to form a pre-cure composition;
cooling the pre-cure composition to room temperature; and
filtering the pre-cure composition through a filter.

2. The method of claim 1, further comprising coating the pre-cure composition on a substrate.

3. The method of claim 2, further comprising heating the pre-cure composition to cure the pre-cure composition and form an FSOF film.

4. The method of claim 1, wherein the fluorinated diol is selected from the group consisting of:
1,1,8,8-dodecafluoro-1,8-octanediol, 2,2,3,3,4,4,5,5-octafluoro-1,6-hexanediol, 2,2,3,3,4,4,5,5,6,6,7,7-dodecanfluoro-1,8-octanediol, 2,2,3,3,4,4,5,5,6,6,7,7,8,8,9,9-perfluorodecane-1,10-diol, (2,3,5,6-tetrafluoro-4-hydroxymethyl-phenyl)-methanol, 2,2,3,3-tetrafluoro-1,4-butanediol, 2,2,3,3,4,4-hexafluoro-1,5-pentanedial, and 2,2,3,3,4,4,5,5,6,6,7,7,8,8-tetradecafluoro-1,9-nonanediol. [Any others?]

5. The method of claim 1, wherein the electroactive segment is selected from the group consisting of N4,N4,N4′,N4′-tetrakis(4-(methoxymethyl)phenyl)biphenyl-4,4′-diamine N,N,N′,N′-tetra-(p-tolyl)biphenyl-4,4′-diamine: and N4,N4′-bis(3,4-dimethylphenyl)-N4,N4′-di-p-tolyl-[1,1′-biphenyl]-4,4′-diamine.

6. The method of claim 1, wherein the solvent is selected from the group consisting of: alkanes, aromatic compounds, ethers, esters, ketones amines, amides, alcohols, halogenated aromatics, halogenated alkanes and water.

7. The method of claim 1, wherein the catalyst is selected from the group consisting of:
hydrochloric acid, acetic acid, p-toluenesulfonic acid, amine-protected p-toluenesulfonic acid, sodium hydroxide, lithium hydroxide, potassium hydroxide, amines, N,N-dimethyl-4-aminopyridine, metals, metal salts and metal complexes.

8. The method of claim 1, wherein the filter is a 0.45 micron PTFE filter.

9. The method of claim 1, wherein the mixing is performed at a first speed and then increased to a second speed.

10. The method of claim 1, wherein the leveling agent comprises hydroxyl-functionalized silicone modified polyacrylate.

11. A method of manufacturing a fluorinated structured organic film (FSOF) composition comprising:
combining a fluorinated molecular building block, a hole transport building block and a solvent to form a composition;
adding the composition to a round bottom reactor;
heating, without mixing, the round bottom reactor to a temperature of between 72° C. and 85° C. for a period of time to dissolve the fluorinated molecular building block;
mixing the heated mixture at a first speed and then increasing the mixing to a second speed for the period of time sufficient to dissolve the hole transport building block at a temperature of between 72° C. and 85° C.;
adding a catalyst and leveling agent to the mixed heated mixture to initiate a pre-cure reaction and allowing the pre-cure reaction to proceed for at least 2 hours at a temperature of between 72° C. and 85° C. to form a pre-cure composition;
cooling the pre-cure composition to room temperature; and
filtering the pre-cure composition through a filter.

12. The method of claim 11, further comprising coating the pre-cure composition on a substrate.

13. The method of claim 12, further comprising heating the pre-cure composition to cure the pre-cure composition and form a FSOF film.

14. The method of claim 11, wherein the fluorinated building block is selected from the group consisting of: α, ω-fluoroalkyldiols of the general structure: 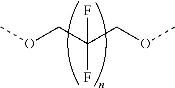
where n is an integer having a value of from 1 to about 100; fluorinated alcohols of the structure HOCH₂(CF₂).CH₂OH where n is an integer having a value of from 1 to about 100;
tetrafluorohydroquinone; perfluoroadipic acid hydrate; 4,4′-(hexafluoroisopropylidene)diphthalic anhydride; and 4,4′-(hexafluoroisopropylidene)diphenol.

15. The method of claim 11, wherein the hole transport building block is selected from the group consisting of: N,N,N′,N′-tetrakis-[(4-hydroxymethyl)phenyl]-biphenyl-4,4′-diamine having a hydroxyl functional group (—OH); and/or N,N′-diphenyl-N,N′-bis-(3-hydroxyphenyl)-biphenyl-4,4′-diamine having a hydroxyl functional group (—OH).

16. The method of claim 11, wherein the solvent is selected from the group consisting of:
alkanes, aromatic compounds, ethers, esters, ketones amines, amides, alcohols, halogenated aromatics, halogenated alkanes and water.

17. The method of claim 11, wherein the catalyst is selected from the group consisting of:
hydrochloric acid, acetic acid, p-toluenesulfonic acid, amine-protected p-toluenesulfonic acid, sodium hydroxide, lithium hydroxide, potassium hydroxide, amines, N,N-dimethyl-4-aminopyridine, metals, metal salts and metal complexes.

18. A method of manufacturing a fluorinated structured organic film (FSOF) composition comprising:
combining 1,1,8,8-dodecafluoro-1,8-octanediol, N4,N4,N4′,N4′-tetrakis(4-(methoxymethyl)phenyl)biphenyl-4,4′-diamine and dipropylene glycol methyl ether to form a composition;
adding the composition to a round bottom non-reactive reactor;
heating, without mixing, the round bottom non-reactive reactor to a temperature of between 80 and 85° C. for a period of time to dissolve the 1,1,8,8-dodecafluoro-1,8-octanediol in the dipropylene glycol methyl ether;
mixing the heated mixture for the period of time sufficient to dissolve the N4,N4,N4′,N4′-tetrakis(4-(methoxymethyl)phenyl)biphenyl-4,4′-diamine in the dipropylene glycol methyl ether at a temperature of between 80 and 85° C.;
adding an acid catalyst and leveling agent to the mixed heated mixture to initiate a pre-cure reaction and allowing the pre-cure reaction to proceed for at least 2 hours at a temperature of between 80 and 85° C. to form a pre-cure composition;
cooling the pre-cure composition to room temperature; and
filtering the pre-cure composition through a filter.

19. The method of claim 18, further comprising coating the pre-cure composition on a substrate.

20. The method of claim 19, further comprising heating the pre-cure composition to cure the pre-cure composition and form an FSOF film.
